(19) United States
(12) Patent Application Publication
(10) Pub. No.: US 2025/0085919 A1
(43) Pub. Date: Mar. 13, 2025

(54) SYSTEMS AND METHODS FOR IMPROVED SOCIAL MEDIA AUDIO ROOMS

(71) Applicant: Issac Hayes III, Atlanta, GA (US)

(72) Inventor: Issac Hayes III, Atlanta, GA (US)

(21) Appl. No.: 18/634,407

(22) Filed: Apr. 12, 2024

Related U.S. Application Data
(63) Continuation-in-part of application No. 18/082,397, filed on Dec. 15, 2022.

(51) Int. Cl. G06F 3/16; G06F 3/0484

(52) U.S. Cl. CPC G06F 3/165; G06F 3/0484

(57) ABSTRACT

Systems and methods for improved social media audio rooms are disclosed. A server receives an audio room creation option from a first user device. The server then receives screen text, at least one background image, at least one audio room logo, and a header image from the first user device. The server generates an audio room that displays the at least one background image, the at least one audio room logo, and the header image. The server can also assign the first user account as moderator of the audio room, such that the first user account can determine which users access the audio room and when/if the other users can access the microphone associated with the audio room.

### CROSS-REFERENCE TO RELATED APPLICATION

This application claims the benefit, under 35 U.S.C. § 119(e), of U.S. Provisional Patent Application No. 63/289,731, filed Dec. 15, 2021, and U.S. patent application Ser. No. 18/082,397, filed Dec. 15, 2022, the contents of which are hereby incorporated by reference herein in their entirety as if fully set forth below.

### FIELD OF INVENTION

The present disclosure relates to systems and methods for improved social media audio rooms, and more particularly to systems and methods that customize social media audio rooms while also facilitating monetization.

### BACKGROUND

Currently, various social media platforms exist that provide, for example, audio chat rooms, live streaming, filters, video and photo sharing, likes, comments, and shares. Social media users have enjoyed some of these features for years. A few users have even become content creators who can generate significant profits from their content and newfound celebrity. While some content creators can monetize their content and social media presence, many social media users are often unable to profit from their content.

Accordingly, there is a need for systems and methods for monetizing social media while providing an enhanced social media experience. Examples of the present disclosure are directed to this and other considerations.

### SUMMARY

Disclosed examples provide systems and methods for improved social media audio rooms.

Consistent with the disclosed examples, various methods and systems are disclosed. In one example, a method for generating a social media audio room is disclosed. The method may be implemented with a server. The method may include receiving a request from a user (e.g., first user account) of the first social media application, to generate a first audio room for the first social media application. The method may further include generating a first audio room based on the user request. The first user account may also receive a room name for the first audio room from the first user account that can be assigned to the first audio room. The method may further include generating a universe resource locator (URL) for the first audio room. The server may also receive one or more audio room logos, background images, and/or screen texts that can be displayed on the screen of the first audio room. Additionally, the server may assign the first user account as moderator of the first audio room.

In some examples, the one or more audio room logos may be displayed one at a time or together at timed intervals at various locations on the screen of the first audio room. Similarly, the one or more background images may be displayed one at a time or together at timed intervals on the screen of the first audio room.

In some examples, the first social media provider server may receive an invitation request from the first user account that enables a second user account to join the first audio room. Based on the invitation request, the first social media provider server may enable the second user account to access the first audio room. By accessing the first audio room, the second user account may be able to participate in audio conversations with other users who are in the first audio room.

In some examples, the second user account is subscribed to the first user account such that the second user account may access the first audio room based on the subscription.

In other examples, the second user account obtains the invitation notification to access the first audio room after donating at least a required amount to the first user account.

In some examples, the first audio room is accessible to all user accounts of the first social media application.

In another example, a method for generating a social media audio room is disclosed from the perspective of a user. The user may request the establishment of a social audio room using a user device such as, for example, a smartphone, tablet, or laptop. In this example, the first user account, via the first social media application, may select a first audio room creation option. This first audio room creation option can be sent to the first social media provider server. The first user account may also send a room name for the first audio room, which can be used to generate a URL for the first audio room. Furthermore, the first social media provider server may send the URL to the first user account, so that the first user can share the URL with other users. Next, the first user account may send one or more audio room logos, one or more background images, and/or screen text to the first social media provider server. Also, the first user account may send, to the first social media provider server, an instruction for an action to be associated with the screen text. The first user account may also send an accessibility option the first social media provider server that decides which user accounts can access the first audio room.

In some examples, rather that the first user account interacting with the first social media provider server to create the first audio room, a first social media representative can manually generate the first audio room in a similar fashion, as described above, using a backend console.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an example environment that may be used to implement one or more embodiments of the present disclosure, according to example embodiments;

FIG. 2 is an example flow chart for a method of creating a first audio room from the prospective of a first social media provider server, according to example embodiments;

FIG. 3 is another example flow chart for a method of creating the first audio room from the prospective of a user device, according to example embodiments;

FIG. 4 depicts a graphical user interface that facilitates the creation of the first audio room, according to example embodiments;

FIG. 5 illustrates the first audio room, according to example embodiments;

FIG. 6 is a component diagram of an example of a user device, in accordance with some examples of the present disclosure; and

FIG. 7 is a component diagram of an example of a server, in accordance with some examples of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to example embodiments of the disclosed technology, examples of which are illustrated in the accompanying drawings and disclosed herein. Wherever convenient, the same references numbers will be used throughout the drawings to refer to the same or like parts.

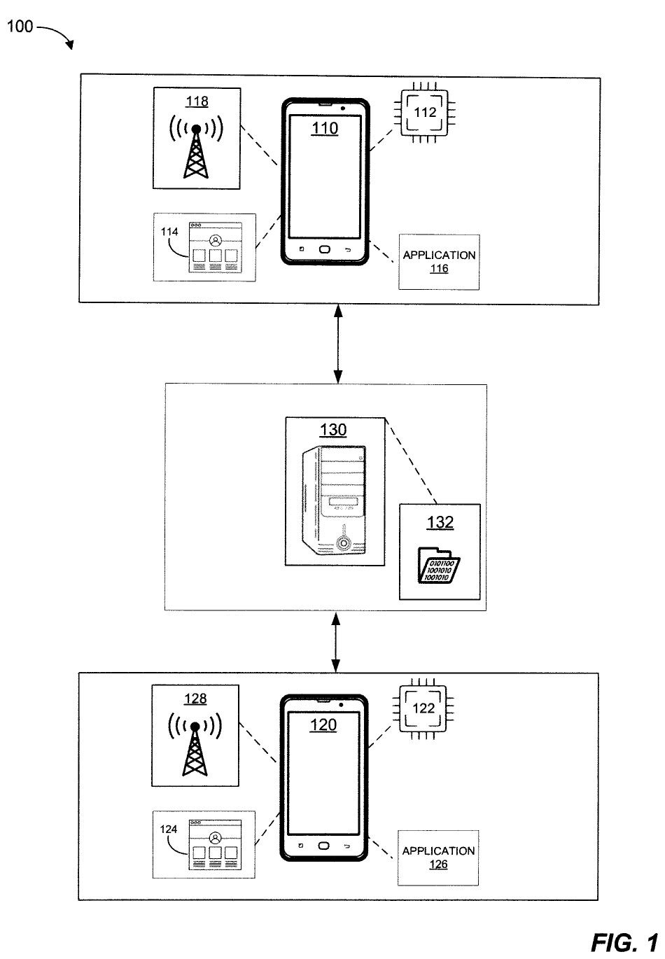

FIG. 1 shows an example system 100 that may implement certain methods for improved social media audio rooms as disclosed herein. As shown in FIG. 1, in some implementations the system 100 can include a first user device 110 (e.g., a smartphone), which may include a first processor 112, a first graphical user interface (first GUI) 114, a first social media application 116, and a first transceiver 118, a first social media provider server 130, which may include social media software 132, and a second user device 120 (e.g., a smartphone). Similar to the first user device 110, the second user device 120 may include a second processor 122, a second graphical user interface (second GUI) 124, a second social media application 126, and a second transceiver 128.

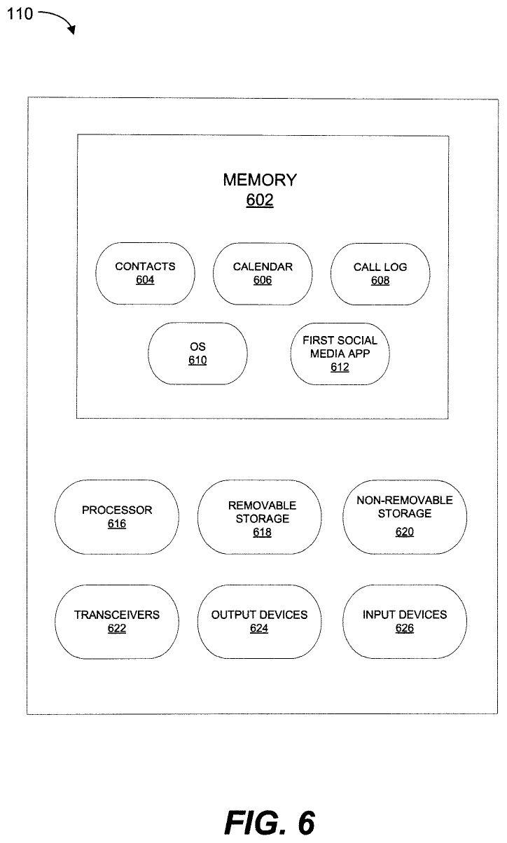

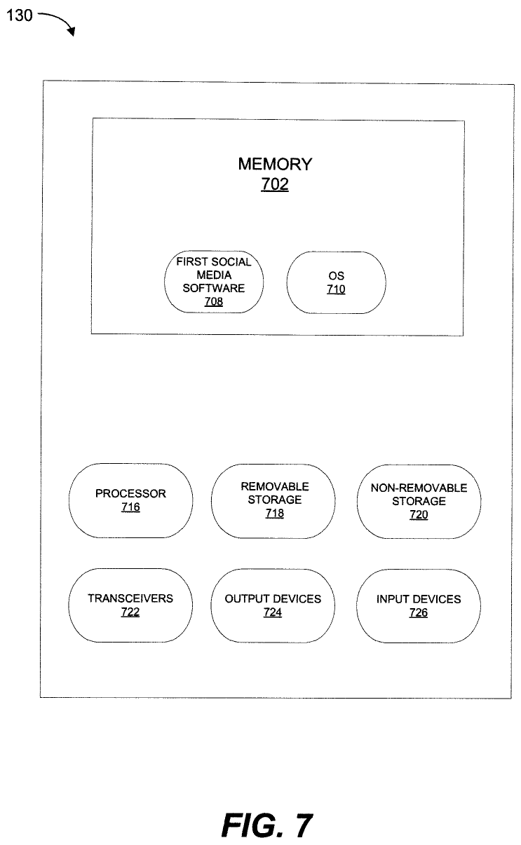

For purposes of this disclosure, the first user device 110 and the second user device 120 may perform the same or similar functions. The first user device 110 can be, for example, a personal computer, a smartphone, a smart television (TV), a laptop computer, a tablet, a wearable device (e.g., smart watch, smart jewelry, head-mounted displays, etc.), or other computing device. An example computer architecture that can be used to implement the first user device 110 is described below with reference to FIG. 6. The first social media provider server 130 can include one or more physical or logical devices (e.g., servers) or drives and may be implemented as a single server, a bank of servers (e.g., in a “cloud”), run on a local machine, or run on a remote server. An example computer architecture that can be used to implement the first social media provider server 130 is described below with reference to FIG. 7.

To create a first audio room, a first user account using the first user device 110 can select a first audio room creation option from the first social media application 116. Next, the first transceiver 118 can send the first audio room option to the first social media provider server 130. The first transceiver 118 can also send a room name to the first social media provider server 130, which, in turn, can send a universal resource locator (URL) for the first audio room to the first user device 110. The first user account, using the first transceiver 118, can also send to the first social media provider server 130 at least one or more of the following: audio room logos; and background images. Furthermore, the first user account can send screen text to the first social media provider server 130. The screen text, audio room logo(s), and/or background image(s) can all be used by the social media software 132 to generate the first audio room. The first user account can also send instructions to determine the placement of the audio room logo(s) and screen text within the first audio room. Also, the first user account can send instructions to determine how long a background image is displayed and whether it rotates with other background images. Additionally, the first user account can send instructions to the first social media provider server 130 that determine which user accounts can access the first audio room.

In substantially the same or similar manner as the first user device 110, the second user device 120 can perform social media services in tandem with the first social media provider server 130.

The first social media provider server 130 can receive the first audio room creation option from the first user device 110. Upon receiving the first audio room creation option, the first social media provider server 130 can generate the first audio room, or the first social media provider 130 can accept the request then, receive the screen text, background image(s), and/or audio room logo(s), and then generate the first audio room. The first social media provider server 130 can then send a URL for the first audio room to the first user device 110. Once the first audio room is created, the first social media provider server 130 can output for display the first audio room which includes the screen text, background image(s), and/or audio room logo(s).

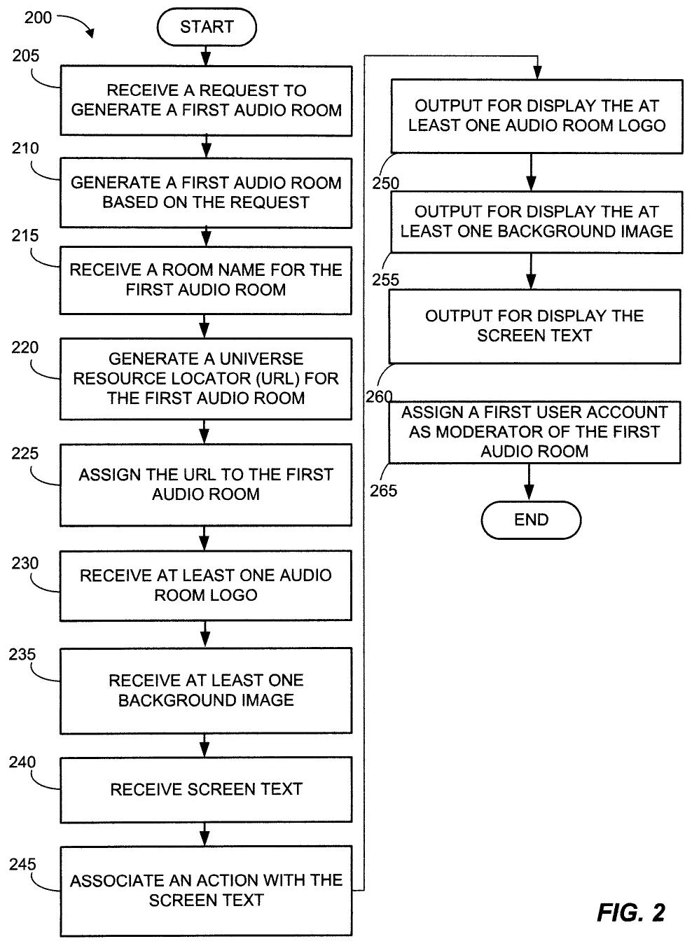

FIG. 2 depicts a method 200 of creating a first audio room from the prospective of a social media server (e.g., first social media provider server 130). At 205, the social media provider server 130 receives a first audio room creation option (request) from a first user account (e.g., first user device 110). Next, at 210, the first social media provider server 130 generates a first audio room based on the request. At 215, the first social media provider server 130 receives a name for the first audio room from the first user account. Then, at 220, the first social media provider server 130 generates a URL for the first audio room that it assigns to the first audio room at 225.

At 230, the first social media provider server 130 receives at least one audio room logo from the first user device 110. Similarly, at 235 and 240, respectively, the first social media provider server 130 receives at least one background image and screen text from the first user device 110. At 245, the first social media provider server 130 associates an action with the screen text (e.g., a URL to be associated with the screen text, opening an application such as second social media application, or even another action of the first social media application). Then, at 250, 255, and 260, respectively, the first social media provider server 130 outputs for display the audio room logo(s), background image(s), and the screen text. Finally, at 265, the first social media provider server 130 assigns the first user account as a moderator of the room, i.e., the first user account can determine various settings for the first audio room including who can access the room, who can control the microphone in the room, etc.

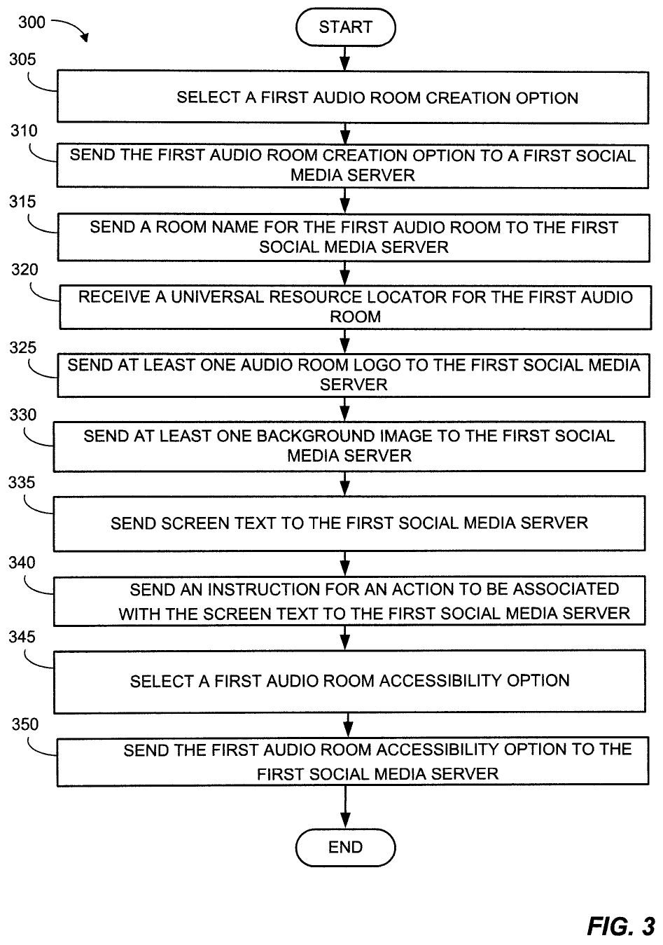

Turning to FIG. 3, which illustrates a method of creating a first audio room from the prospective of a first user account (e.g., first user device 110). At 305, the first user device 100, using the first social media application 116, selects the first audio room creation option. At 310, the first user device 110 sends the first audio room creation option (request) to the first social media provider server 130. Next, at 315, the first user device 110 sends a room name for the first audio room to the first social media provider server 130. In turn, the first user device 100 receives a URL for the first audio room from the first social media provider server 130, at 320.

At 325, 330, 335, and 340, respectively, the first user device 110 sends audio room logo(s), background image(s), screen text, and instructions for an action to be associated with the screen text to the first social media provider server 130. At 345, the first user device 110 selects an accessibility option, for example, who can access the first audio room. In some cases, all user accounts can access the first audio room. In other cases, only subscribed user accounts can access the first audio room. And, in other cases, only user accounts that have donated at least a required amount to the first user account can access the first audio room. Once the accessibility option is selected, the first user device 110 sends the first audio room accessibility option to the first social media server 130.

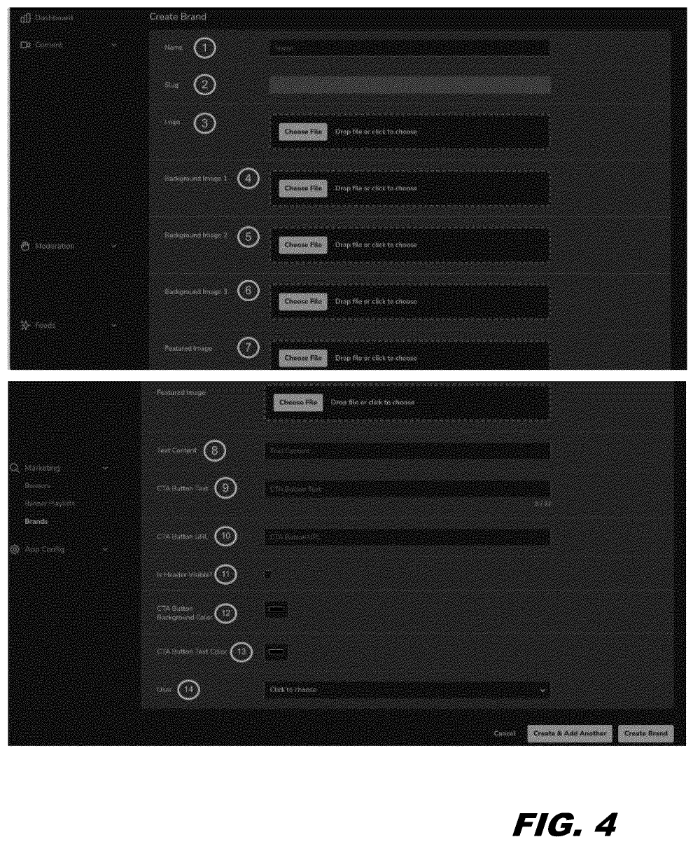

FIG. 4 depicts a graphical user interface that facilitates the creation of the first audio room. As shown, the first social media application 116 can be displayed as the first GUI 114. The first GUI 114 represents a backend console for the first social media application 116. The first GUI 114 provides several options, as described above, for customizing the first audio room. For example, the room name, audio room logo(s), background images(s), screen text, and user accessibility options can be performed from the first GUI 114.

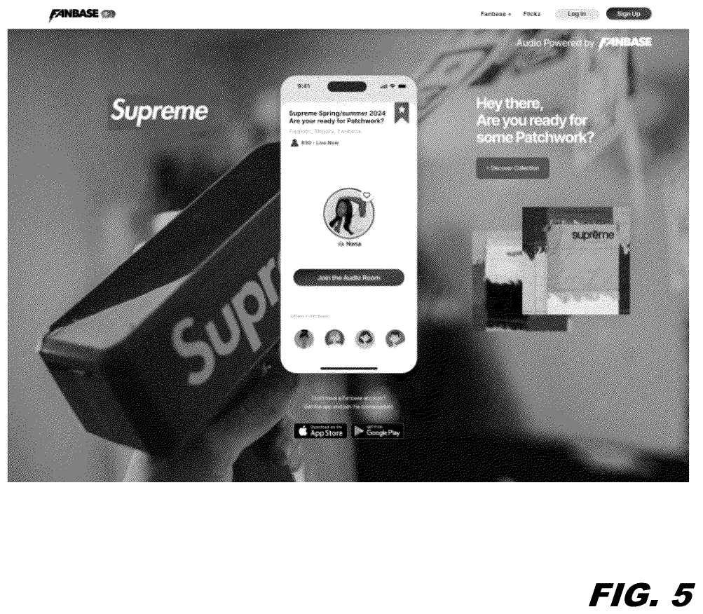

FIG. 5 illustrates the first audio room as displayed, for example, by the first GUI 114. As depicted in FIG. 5, the first audio room can include a header (positioned at the top right) that, in this case, displays the social media provider, Fanbase®. The first audio room can include a background image such as the Supreme® image. The background image can be a featured image that is shown throughout, or that is featured more often than other rotating background images. Regarding the rotating background images, there can be a plurality of background images that rotate at various intervals. Also, audio room logo(s) can be displayed, such as the Supreme® logo shown here. Furthermore, the first audio room can include screen text associated with an action such as the text, “Hey there, Are you ready for some Patchwork?” as shown on the first GUI 114.

As shown in FIG. 6, some, or all, of the system 100 and methods 200 and 300 can be performed by, and/or in conjunction with, the first user device 110 and/or the second user device 120. For brevity, only the first user device 110 shall be used to in the description of this figure. In some examples, the first user device 110 can comprise, for example, a cell phone, a smart phone, a smart television, a tablet computer, a laptop computer, a desktop computer, a sever, or other electronic device. One of skill in the art will recognize, however, that the system 100 and methods 200 and 300 can also be used with a variety of other electronic devices, such as, for example, tablet computers, laptops, desktops, and other network (e.g., cellular or internet protocol (IP) network) connected devices from which a call may be placed, a text may be sent, and/or data may be received. These devices are referred to collectively herein as the first user device 110. The first user device 110 can comprise a number of components to execute the above-mentioned functions and apps. As discussed below, the first user device 110 comprise memory 602 including many common features such as, for example, contacts 604, a calendar 606, a call log (or, call history) 608, and OS 610. In this case, the memory 602 can also store a first social media app 612.

The first user device 110 can also comprise one or more processors 66. In some implementations, the processor(s) 616 can be a central processing unit (CPU), a graphics processing unit (GPU), or both CPU and GPU, or any other sort of processing unit. The first user device 110 can also include one or more of removable storage 618, non-removable storage 620, one or more transceiver(s) 622, output device(s) 624, and input device(s) 626.

In various implementations, the memory 602 can be volatile (such as random-access memory (RAM)), non-volatile (such as read only memory (ROM), flash memory, etc.), or some combination of the two. The memory 602 can include all, or part, of the functions 604, 606, 608, 612, and the OS 610 for the first user device 110, among other things.

The memory 602 can also comprise contacts 604, which can include names, numbers, addresses, and other information about the user's business and personal acquaintances, among other things. In some examples, the memory 602 may also include a calendar 606, or other software, to enable the user to track appointments and calls, schedule meetings, and provide similar functions. In some examples, the memory 602 can also comprise the call log 608 of calls received, missed, and placed from the first user device 110. As usual, the call log 608 can include timestamps for each call for use by the system 100. Of course, the memory 602 can also include other software such as, for example, e-mail, text messaging, social media, and utilities (e.g., calculators, clocks, compasses, etc.).

The memory 602 can also include the OS 610. Of course, the OS 610 varies depending on the manufacturer of the first user device 110 and currently comprises, for example, iOS 14.4.2 for Apple products and Pie for Android products. The OS 610 contains the modules and software that supports a computer's basic functions, such as scheduling tasks, executing applications, and controlling peripherals.

As mentioned above, the first user device 110 can also include the first social media app 612. The first social media app 612 can perform some, or all, of the functions discussed above with respect to the methods 200 and 300 for interactions occurring between the first user device 110, the first social media provider server 130, and the second user device 120. Thus, the first social media app 612 can transmit user data to the first social media provider server 130. Additionally, the first social media app 612 can receive first social media content from the user and transmit the user data to the first social media provider server 130. The first social media app 612 also can receive, from the first social media provider server 130, social media content from various other social media profiles associated with the first social media application. Based on the user preferences and the location information, the first social media app 612 can generate demographics information. Further, the first social media app 612 can interact with the contacts 604 to identify contacts who have profiles on the first social media application.

The first user device 110 can also include additional data storage devices (removable and/or non-removable) such as, for example, magnetic disks, optical disks, or tape. Such additional storage is illustrated in FIG. 6 by removable storage 618 and non-removable storage 620. The removable storage 618 and non-removable storage 620 can store some, or all, of the functions 604, 606, 608, 612, and the OS 610.

Non-transitory computer-readable media may include volatile and nonvolatile, removable and non-removable tangible, physical media implemented in technology for storage of information, such as computer readable instructions, data structures, program modules, or other data. The memory 602, removable storage 618, and non-removable storage 620 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store the desired information and which can be accessed by the first user device 110. Any such non-transitory computer-readable media may be part of the first user device 110 or may be a separate database, databank, remote server, or cloud-based server.

In some implementations, the transceiver(s) 622 include any sort of transceivers known in the art. In some examples, the transceiver(s) 622 can include wireless modem(s) to facilitate wireless connectivity with the other user devices, the Internet, and/or an intranet via a cellular connection.

In other examples, the transceiver(s) 622 can include wired communication components, such as a wired modem or Ethernet port, for communicating with the other user devices or the provider's Internet-based network. In this case, the transceiver(s) 622 can also enable the first user device 110 to communicate with the first social media provider server 130, as described herein.

In some implementations, the output device(s) 624 include any sort of output devices known in the art, such as a display (e.g., a liquid crystal or thin-film transistor (TFT) display), a touchscreen display, speakers, a vibrating mechanism, or a tactile feedback mechanism. In some examples, the output device(s) 624 can play various sounds based on, for example, whether the first user device 110 is connected to a network, the type of call being received (e.g., video calls vs. voice calls), the number of active calls, etc. In some examples, the output device(s) can play a sound when the first social media app 612 is successfully downloaded, when the user enters user preferences, etc. Output device(s) 624 can also include ports for one or more peripheral devices, such as headphones, peripheral speakers, or a peripheral display.

In various implementations, input device(s) 626 can include any sort of input devices known in the art. The input device(s) 626 can include, for example, a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

As shown in FIG. 7, the system 100 and methods 200 and 300 can also be used in conjunction with the first social media provider server 130. The first social media provider server 130 can comprise, for example, a desktop or laptop computer, a server, bank of servers, or cloud-based server bank. Thus, while the first social media provider server 130 is depicted as single standalone servers, other configurations or existing components could be used.

In various implementations, the memory 702 can be volatile (such as random-access memory (RAM)), non-volatile (such as read only memory (ROM), flash memory, etc.), or some combination of the two. The memory 702 can include all, or part, of the functions of first social media software 708, among other things. The memory 702 may also include the OS 710. Many servers, for example, run Linux or Windows Server. The OS 710 contains the modules and software that supports a computer's basic functions, such as scheduling tasks, executing applications, and controlling peripherals.

The first social media provider server 130 can also comprise one or more processors 716, which can include a central processing unit (CPU), a graphics processing unit (GPU), or both CPU and GPU, or any other sort of processing unit. The first social media software 708 can provide the first social media provider server 130 communication with the second user device 120 and/or the first user device 110. Thus, the first social media software 708 can receive demographics information, location information, user preferences, and other information from the second user device 120 and/or the first user device 110. Also, the first social media software 708 can receive and distribute social media content from and to the second user device 120 and/or the first user device 110.

The first social media provider server 130 can also include additional data storage devices (removable and/or non-removable) such as, for example, magnetic disks, optical disks, or tape. Such additional storage is illustrated in FIG. 7 by removable storage 718 and non-removable storage 720. The removable storage 718 and non-removable storage 720 may store some, or all, of the OS 710 and functions 708.

Non-transitory computer-readable media may include volatile and nonvolatile, removable and non-removable tangible, physical media implemented in technology for storage of information, such as computer readable instructions, data structures, program modules, or other data. The memory 702, removable storage 718, and non-removable storage 720 are all examples of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which may be used to store the desired information, and which can be accessed by the first social media provider server 130. Any such non-transitory computer-readable media may be part of the first social media provider server 130 or can be a separate database, databank, remote server, or cloud-based server.

In some implementations, the transceiver(s) 722 include any sort of transceivers known in the art. In some examples, the transceiver(s) 722 may include wireless modem(s) to facilitate wireless connectivity with the first user device 110, the Internet, and/or an intranet via a cellular connection. Further, the transceiver(s) 722 can include a radio transceiver that performs the function of transmitting and receiving radio frequency communications via an antenna (e.g., Wi-Fi or Bluetooth®). In other examples, the transceiver(s) 722 can include wired communication components, such as a wired modem or Ethernet port, for communicating with the other user devices or the provider's Internet-based network. The transceiver(s) 722 can retrieve user data (e.g., data associated with a user profile) from memory 702.

In some implementations, the output device(s) 724 include any sort of output devices known in the art, such as a display (e.g., a liquid crystal or thin-film transistor (TFT) display), a touchscreen display, speakers, a vibrating mechanism, or a tactile feedback mechanism. In some examples, the output devices may play various sounds based on, for example, whether the first social media provider server 130 is connected to a network, the type of data being received (e.g., user data vs. social media content), when the request is being transmitted, etc. Output device(s) 724 also include ports for one or more peripheral devices, such as headphones, peripheral speakers, or a peripheral display.

In various implementations, input device(s) 726 include any sort of input devices known in the art. For example, the input device(s) 726 can include a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

The specific configurations, machines, and the size and shape of various elements can be varied according to particular design specifications or constraints requiring the first user device 110, the first social media provider server 130, the second user device 120, system 100, or method 200, 300 constructed according to the principles of this disclosure. Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain examples and implementations of the disclosed technology are described above with reference to block and flow diagrams of systems and methods and/or computer program products according to example examples or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some examples or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, examples or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some examples,” “example embodiment,” “various examples,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising,” “containing,” or “including” it is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain examples of this disclosure have been described in connection with what is presently considered to be the most practical and various examples, it is to be understood that this disclosure is not to be limited to the disclosed examples, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain examples of the technology and also to enable any person skilled in the art to practice certain examples of this technology, including making and using any apparatuses or systems and performing any incorporated methods. The patentable scope of certain examples of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for improved social media audio rooms comprising:
receiving, by a transceiver of a server, a first audio room creation option;
generating, by a processor of the server, a first audio room based on the first audio room creation option;
receiving, by the processor, a room name for the first audio room;
assigning, by the processor, the room name to the first audio room;
generating, by the processor, a universal resource locator (URL);
assigning, by the processor, the URL to the first audio room;
receiving, by the transceiver, at least one of a plurality of audio room logos;
receiving, by the transceiver, at least one of a plurality background images;
receiving, by the transceiver, a header image;
receiving, by the transceiver, screen text;
associating, by the processor, an action with the screen text;
outputting for display, by the processor, at least one audio room logo;
outputting for display, by the processor, at least one background image;
outputting for display, by the processor, the header image;
outputting for display, by the processor, the screen text; and
assigning, by the processor, a first user account as a moderator of the first audio room.

2. The method of claim 1, wherein a first audio room logo and second audio room logo are outputted for display, by the processor, at rotating timed intervals.

3. The method of claim 1, further comprising:
receiving, by the transceiver, microphone control instructions from the first user account, wherein the microphone control instructions determine that a second user account can use a microphone associated with the first audio room.

4. The method of claim 1, further comprising:
receiving by the transceiver, an invitation request from the first user account that enables a second user account to join the first audio room;
sending, by the transceiver, an invitation notification to the second user account; and
enabling, by the processor, the second user account to access the first audio room.

5. The method of claim 4, wherein the second user account is subscribed to the first user account.

6. The method of claim 4, wherein the second user account obtains the invitation notification after donating at least a required amount to the first user account.

7. The method of claim 1, wherein the first audio room is accessible to all user accounts of the first social media application.

8. A method for improved social media audio rooms comprising:
selecting, on a first social media application installed on a first user device, a first audio room creation option from a first user account;
sending, by a transceiver of the first user device, the first audio room creation option to a first social media server;
sending, by the transceiver, a room name for the first audio room to the first social media provider server;
receiving, by the transceiver, a universal resource locator (URL) to the first audio room from the first social media server;
sending, by the transceiver, at least one audio room logo to the first social media server;
sending, by the transceiver, at least one background image to the first social media server;
sending, by the transceiver, a header image to the first social media server;
sending, by the transceiver, screen text to the first social media server;
sending, by the transceiver, an instruction for an action to be associated with the screen text to the first social media server;
selecting, on the first social media application, a first audio room accessibility option; and
sending, by the transceiver, the first audio room accessibility option to the first social media server.

9. The method of claim 8, wherein a first audio room logo and second audio room logo are outputted for display, by the processor, at rotating timed intervals.

10. The method of claim 9, wherein the rotating timed intervals are selected by the first user account.

11. The method of claim 8, further comprising:
sending, by the transceiver, an invitation that enables a second user account to join the first audio room to the first social media server.

12. The method of claim 11, wherein the second user account is subscribed to the first user account.

13. The method of claim 11, wherein the first user account sends the invitation notification after the second user account donates a required amount to the first user account.

14. The method of claim 8, wherein the first audio room is accessible to all user accounts of the first social media application.

15. A system for improved social media audio rooms comprising:
one or more processors; and
memory, in communication with the one or more processors, storing instructions that, when executed, cause the one or more processors to:
receive a first audio room creation option;
generate a first audio room based on the first audio room creation option;
receive a room name for the first audio room;
assign the room name to the first audio room;
generate a universal resource locator (URL);
assign the URL to the first audio room;
receive at least one of a plurality of audio room logos;
receive at least one of a plurality background images;
receive a header image;
receive a screen text;
associate an action with the screen text;
output for display at least one audio room logo;
output for display at least one background image;
output for display the header image;
output for display the screen text; and
assign a first user account as a moderator of the first audio room.

16. The system of claim 15, wherein the one or more processor is further configured to:
receive microphone control instructions from the first user account, wherein the microphone control instructions determine that a second user account can use a microphone associated with the first audio room.

17. The system of claim 15, wherein the one or more processor is further configured to:
receive an invitation request from the first user account that enables a second user account to join the first audio room;
send an invitation notification to the second user account; and
enable the second user account to access the first audio room.

18. The system of claim 17, wherein the second user account is subscribed to the first user account.

19. The system of claim 17, wherein the second user account obtains the invitation notification after donating at least a required amount to the first user account.

20. The system of claim 17, wherein the first audio room is accessible to all user accounts of the first social media application.
